(19) United States
(12) Patent Application Publication
(10) Pub. No.: US 2011/0304435 A1
(43) Pub. Date: Dec. 15, 2011

(54) SECURE METHOD FOR TRANSMITTING DATA

(75) Inventors: Eric De Larminat, Laval (FR); Frankie Letellier, Laval (FR)

(73) Assignee: THALES, NEUILLY SUR SEINE (FR)

(21) Appl. No.: 13/139,608

(22) PCT Filed: Dec. 10, 2009
(86) PCT No.: PCT/EP2009/066879

§ 371 Date: Jul. 25, 2011

(30) Foreign Application Priority Data
Dec. 16, 2008 (FR) 0807071

(51) Int. Cl. H04Q 5/22

(52) U.S. Cl. 340/10.1

(57) ABSTRACT

A method for transmitting data between a responder and an interrogator communicating in a secure mode includes the interrogator transmitting an interrogation signal comprising an authentication sequence to the responder which replies to the interrogator with a signal subjected to a time delay depending on said authentication sequence. A message for selection of the type of data to be transmitted is inserted into said interrogation signal, the responder decoding said selection message in order to transmit the selected data to the interrogator, said data being formatted in the form of standard identification codes so as to be masked.

The present invention relates to a secure method for transmitting data. It is notably applicable to the transmission of data between an interrogator and a responder.

The need to transmit data between two remote systems generally imposes the addition of specific equipment. Known techniques can make this additional equipment unnecessary by transmitting data via identification devices already present on the remote systems, these devices being for example interrogators and/or responders.

It is recalled that a large number of craft, for example aircraft, are equipped with responders allowing an identification code to be transmitted which is specific to them. By way of illustration, a transponder placed on a ship transmits an interrogation message; this message is received by the responder on an aircraft, which responder transmits, in return, an identification code of the aircraft. Furthermore, when the mode of transmission is secured, this identification code is returned in a form that is non-decodable for a transponder not equipped with a suitable secret function. Amongst the secure modes, Mode 4 and its derivative NSM, acronym for “National Secure Mode”, are particularly widespread in currently operating equipment.

The patent filed by the US Navy and published under the reference U.S. Pat. No. 6,476,757 discloses a method for transmitting data operating on an IFF responder in which a reply in Mode 2 is transmitted by the responder after the reply in Mode 4 has been sent. However, this mode of operation does not comply with the standard exchange protocols. This method cannot therefore be implemented in the current equipment without applying significant modifications to it.

One aim of the invention is to transmit data between a responder and an interrogator, for example an IFF responder and interrogator, with a high level of security and without the need for significant modification of the responder or of the interrogator. For this purpose, one subject of the invention is a method for transmitting data between a responder and an interrogator communicating in a secure mode in which the interrogator transmits an interrogation signal comprising an authentication sequence to the responder which replies to the interrogator with a signal subjected to a time delay depending on said authentication sequence, the method being characterized in that a message for selection of the type of data to be transmitted is inserted into said interrogation signal, the responder decoding said selection message in order to transmit the selected data to the interrogator, said data being formatted in the form of standard identification codes so as to be masked.

One advantage of the method according to the invention is that it can conform to the NSM protocol, already in very widespread operation in existing equipment.

The transmitted data are thus masked with respect to equipment not implementing the method according to the invention. This is because, seen from the outside, these data seem to be ordinary identification codes that are commonly used.

The method for transmitting data according to the invention can be advantageously used by IFF interrogators, responders and/or transponders to exchange data between several onboard platforms.

According to one embodiment of the method for transmitting data according to the invention, the transmitted data are formatted in the Mark XA format.

According to one embodiment of the method for transmitting data according to the invention, a first coding sequence is used by the responder to code the data to be transmitted to the interrogator, a second coding sequence, linked via a single-valued mathematical equation with the first coding sequence, being used by the interrogator to decode said data. This coding allows the level of protection of the transmitted data to be increased.

The second coding sequence can be equal to the first coding sequence. Furthermore, the coding sequence can be randomly drawn from amongst several pre-recorded coding sequences.

According to one embodiment of the method for transmitting data according to the invention, the first coding sequence is generated by a first cryptographic module which transmits it to the interrogator, the second coding sequence being generated by a second cryptographic module which transmits it to the responder.

The transmissions between the interrogator and the responder can comply with the “National Secure Mode”, or NSM, exchange protocol, the messages exchanged being transmitted in the form of pulse trains, the method being characterized in that it comprises at least the following steps:
the first cryptographic module (103) generates the second coding sequence and transmits it to the interrogator (101);
the interrogator (101) transmits an interrogation signal (254) to the responder (102) comprising the authentication sequence (253b) and a message for selection of the type of data to be transmitted;
the second cryptographic module (104) supplies the first coding sequence (253c) to the responder (102);
in reply to the interrogator, the responder transmits the selected data, coded by the first coding sequence, and formatted in the form of a standard identification code;
the interrogator decodes the transmitted data using the second coding sequence.

Since the NSM protocol is a protocol commonly employed in existing equipment, one advantage of the method according to the invention is that it does not require additional equipment in order to be able to be implemented.

According to another embodiment of the method for transmitting data according to the invention, the responder and the interrogator each access a correspondence table associating authentication sequences with one or more transmission parameters, a transmission parameter being a coding sequence or a time delay or a type of data to be transmitted. According to this embodiment, the cryptographic modules are not needed. This is because it is the authentication sequence that determines what time delay must be applied to the response signal or which coding sequence must be used.

Another subject of the invention is a system for transmission of data between an interrogator and a responder, the system implementing the method for transmitting data such as described hereinabove.

Other features will become apparent upon reading the detailed description that follows, presented by way of non-limiting example and making reference to the appended drawings, which show:

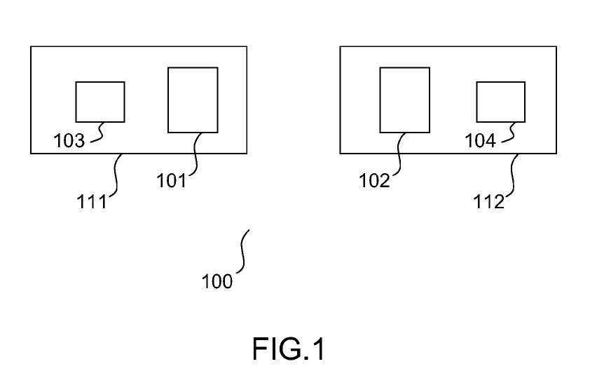

FIG. 1, a system implementing a method for transmitting data according to the invention,

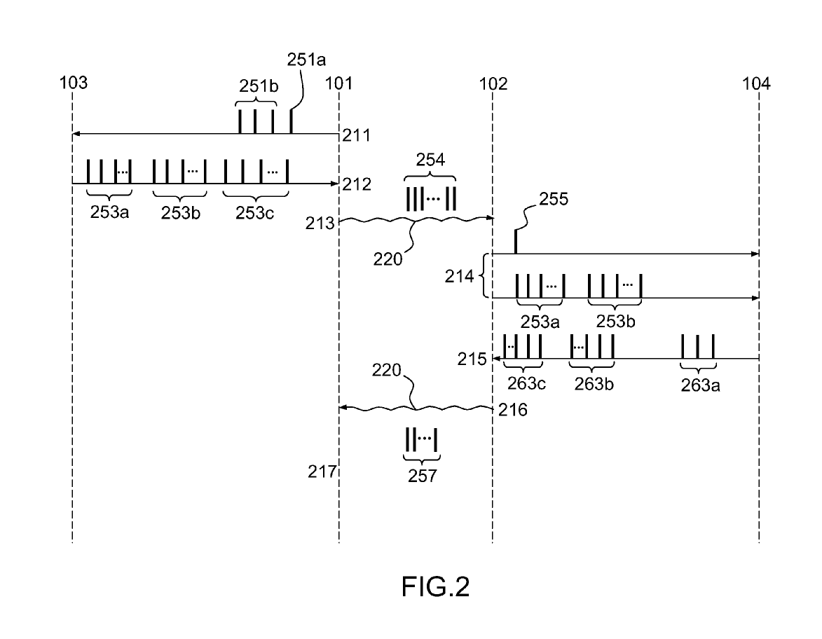

FIG. 2, timing diagrams illustrating the exchanges of messages carried out between the elements of the system in FIG. 1.

For the sake of clarity, the same references in different figures denote the same objects.

FIG. 1 shows a system implementing a method for transmitting data according to the invention. The system 100 comprises an IFF interrogator 101, an IFF responder 102, a first cryptographic module 103 connected to the interrogator 101, and a second cryptographic module 104 connected to the responder 102. The interrogator 101 and the first cryptographic module 103 may be incorporated into a first vessel 111 and the responder 102 and the second cryptographic module 104 can be integrated into a second vessel 112 remote from the first. For example, the first vessel 111 and the second vessel are aircraft, the first aircraft 111 wishing to receive information present on the second aircraft 112, for example avionics data.

FIG. 2 shows timing diagrams illustrating the exchanges of messages carried out during the execution of the method according to the invention. In the example, the method is implemented by the system in FIG. 1.

During a first step 211, the interrogator 101 transmits a control signal 251 to the first cryptographic module 103 in order to request an authentication sequence from the first cryptographic module 103. The control signal 251 comprises, for example, a first pulse 251a triggering the response from the first cryptographic module 103. Aside from this first pulse 251a, conventionally transmitted by interrogators, the control signal 251 transmitted by the method according to the invention can also comprise a data type selection code 251b, where this code 251b can, for example, be a series of pulses allowing the type of data to be chosen that it is desired to receive from the responder 102. The types of data available are, for example, in the case of an aircraft, avionics data such as the heading, the altitude or the speed of the aircraft. In the example, the control signal 251 conforms to the NSM standard. In fact, a conventional NSM control signal 251, composed of a single pulse 251a, is a particular case of pulse train coding a type of NSM interrogation—a single pulse conventionally corresponds to an NSM interrogation of the “identification” type. The method according to the invention thus ‘hijacks’ the conventional use of the NSM format to include in it a data type selection code 251b. Lastly, if no data selection code 251b is transmitted by the interrogator 101, then the conventional NSM mode of interrogation is triggered.

In a second step 212, the first cryptographic module 103 responds to the control signal 251 transmitted by the interrogator 101 by transmitting a trigger signal 253 comprising an interrogation preamble 253a and an authentication sequence 253b. Aside from this interrogation preamble 253a and this authentication sequence 253b, used by conventional NSM systems, the trigger signal 253 transmitted by the interrogator 101 also comprises a coding sequence 253c which will be used later for decoding the data transmitted by the responder 102. Furthermore, the authentication sequence 253b, generated by the first cryptographic module 103, depends on the control signal 215 previously received by said cryptographic module 103, notably, on the presence or absence of the data type selection code 251b. Furthermore, if a data type selection code 251b is present, the value of the authentication sequence 253b depends on the value of said code 251b. In the example, the interrogation preamble 253a, the authentication sequence 253b and the coding sequence 253c are consecutive pulse trains.

In a third step 213, the interrogator 101 transmits an interrogation signal 254 to the responder 102 comprising the interrogation preamble 253a and the authentication sequence 253b, the communication being effected in the example via a radio link 220. The interrogation signal 254 conforms to the format of a conventional NSM interrogation.

In a fourth step 214, having received the interrogation signal 254 transmitted by the interrogator 101, the responder 102 propagates the information carried by said signal 254 to the second cryptographic module 104. In the example, this information is coded by a pulse train. In the example, the responder 102 also generates a trigger signal 255 for a transaction with the second cryptographic module 104. In the example, the trigger signal 255 is a simple pulse.

In a fifth step 215, the second cryptographic module 104 interprets the authentication sequence 253b contained in the interrogation signal 254 that it receives.

If the value of the authentication sequence 253b indicates that no data type selection code 251b had been transmitted by the interrogator 101, then the second cryptographic module 104 goes into conventional interrogation mode, not shown in FIG. 2.

On the other hand, if the value of the authentication sequence 253b indicates that a data type selection code 251b had been transmitted by the interrogator 101, then the second cryptographic module 104 goes into data transmission mode, this mode being specific to the invention. Several cases can then be presented:
the interrogation signal 254 is not complete, in other words, it does not correspond to a recognized format, for example if pulses are missing or if there is an excess of pulses in the pulse train of said signal 253; in this case, the second cryptographic module 104 generates an error signal, preferably at a dedicated output connected to the responder 102, this error signal being advantageously generated as soon as the error is detected;
the interrogation signal 254 is complete but the authentication sequence 253b is not recognized by the second cryptographic module 104; in this case, the second cryptographic module 104 generates an error signal, preferably at a dedicated output connected to the responder 102, this signal being for example generated after a fixed period of time has passed after reception of the preamble 253a of the interrogation signal 254;
the interrogation signal 254 is complete and the authentication sequence 253b is recognized by the second cryptographic module 104.

In the latter case, the second cryptographic module 104 generates a response signal 263a delayed by a period of time chosen from amongst N possible values, the delay time chosen being coded within the authentication sequence 253b. In the example of an interrogation of the NSM type, the delay time is chosen from amongst 16 possible values. In the example, the delayed response signal 263a is an n-uplet of pulses—for example, a triplet for the NSM protocol—delayed by a time TR with respect to the trigger signal 255.

Aside from this conventional delayed response signal 263a, the second cryptographic module 104 extracts from the authentication sequence 253b the type of data 263b to be transmitted, which type of data corresponds to the data type selection code 251b initially transmitted by the interrogator 101—it is recalled that the data type selection code 251b is optional. Subsequently, the second cryptographic module 104 transmits, to the responder 102, a pulse train comprising the following information:
the type of data to be transmitted 263b, this information having been previously decoded from the authentication sequence 253b;
another coding sequence 263c, mathematically linked to the coding sequence 263c used by the interrogator 101.

In a sixth step 216, the responder 102 recovers, from the platform on which it is installed, the data to be transmitted depending on the type of data 263b requested, then the responder 102 encodes this data using the coding sequence 263c produced by the second cryptographic module 104. The encoded data are then transmitted by the responder 102 to the interrogator 101 via a response signal 257 taking the form, in the example, of a pulse train, the signal being for example transmitted via a radio link 220. Advantageously, the data are formatted to resemble an identification code in the Mark XA format, such that equipment not implementing the method according to the invention consider the pulse train coding the data as an ordinary identification code.

There is a separation between the uncoded data to be encoded then to be transmitted and the coding sequence 263c and authentication sequence 253b. Indeed, only the cryptographic modules 103, 104 can interpret the authentication sequence 253b and the coding sequences 253c, 263c, and uncoded data never transits via one of these cryptographic modules 103, 104. The data to be transmitted are encoded or decoded by the interrogator 101 and/or the responder 102 using the coding sequences 253c, 263c transmitted by the associated cryptographic modules 103, 104.

In a seventh step 217, the interrogator 101 decodes the encoded data carried by the signal 257 using the coding sequence 253c produced by the first cryptographic module 103. Furthermore, the delayed response signal 263a is transmitted to the first cryptographic module 103. The first cryptographic module 103 produces a signal S after a time delay which, if the interrogator 101 and the responder 102 use compatible cryptographic keys, compensates the time delay encoded by the second cryptographic module 104. The interrogator 101 then verifies that the signal S is subjected to the expected time delay.

According to another embodiment of the method according to the invention, the cryptographic modules do not exist and the interrogator and the responder store a correspondence table associating authentication sequences with one or more of the transmission parameters which are the time delay, the coding sequence or the type of data requested. According to this embodiment, an authentication sequence 253b is first of all chosen at the interrogator 101, then, when the responder 102 receives this authentication sequence 253b, it deduces from this a time delay and/or a coding sequence to be applied for coding the data to be transmitted.

One advantage of the method for transmitting data according to the invention is that it can readily be implemented on existing hardware equipment, by applying a simple software update.

1. A method for transmitting data between a responder and an interrogator communicating in a secure mode, the method comprising:
the interrogator transmitting an interrogation signal comprising an authentication sequence to the responder, a message for selection of the type of data to be transmitted is inserted into said interrogation signal
the responder replying to the interrogator with a signal subjected to a time delay depending on said authentication sequence, and decoding said selection message in order to transmit the selected data to the interrogator, said data being formatted in the form of standard identification codes so as to be masked.

2. The method according to claim 1, wherein the transmitted data are formatted in the Mark XA format.

3. The method according to claim 1, wherein
a first coding sequence is used by the responder to code the data to be transmitted to the interrogator, and
a second coding sequence, linked via a single-valued mathematical equation with the first coding sequence, is used by the interrogator to decode said data.

4. The method according to claim 3, wherein the second coding sequence is equal to the first coding sequence.

5. The method according to claim 4, wherein the coding sequence is randomly drawn from amongst several pre-recorded coding sequences.

6. The method according to claim 1, wherein
the first coding sequence is generated by a first cryptographic module which transmits it to the interrogator, and
the second coding sequence is generated by a second cryptographic module which transmits it to the responder.

7. The method according to claim 6, wherein transmissions between the interrogator and the responder comply with the “National Secure Mode” exchange protocol, and the messages exchanged are transmitted in the form of pulse trains, the method further comprising:
the first cryptographic module generating the second coding sequence and transmitting the second coding sequence to the interrogator;
the interrogator transmitting the interrogation signal to the responder comprising the authentication sequence and the message for selection of the type of data to be transmitted;
the second cryptographic module supplying the first coding sequence to the responder;
in reply to the interrogator, the responder transmitting the selected data, coded by the first coding sequence, and formatted in the form of a standard identification code; and
the interrogator decoding the transmitted data using the second coding sequence.

8. The method according to claim 1, wherein the responder and the interrogator each access a correspondence table associating authentication sequences with one or more transmission parameters, a transmission parameter being a coding sequence or a time delay or a type of data to be transmitted.

9. A system for transmission of data between an interrogator and a responder, the system implementing the method according to claim 1.
